(19) United States
(12) Patent Application Publication
(10) Pub. No.: US 2026/0172259 A1
(43) Pub. Date: Jun. 18, 2026

(54) HARDWARE EQUIPMENT MANAGEMENT USING BLOCKCHAIN

(71) Applicant: ENP Technologies, Katy, TX (US)

(72) Inventor: Pranav Tiwari, Katy, TX (US)

(21) Appl. No.: 18/847,484

(22) PCT Filed: Aug. 30, 2024
(86) PCT No.: PCT/US2024/044666

§ 371 Date: Sep. 16, 2024

Related U.S. Application Data
(60) Provisional application No. 63/580,837, filed on Sep. 6, 2023.

(51) Int. Cl. H04L 9/32; H04L 9/00

(52) U.S. Cl. CPC H04L 9/3236; H04L 9/50; H04L 2209/56

(57) ABSTRACT

A method includes generating a data representation of a piece of hardware equipment. The method further includes generating a cryptographic hash of 1) the data representation of the piece hardware equipment combined with 2) a hash of a previous piece of hardware equipment on a blockchain data structure. The method further includes adding the data representation of the hardware equipment to the blockchain data structure, storing a copy of the blockchain data structure, and using the generated cryptographic hash similarly for a next piece of hardware equipment.

### CROSS-REFERENCE TO RELATED APPLICATIONS

This application claims the benefit of U.S. Provisional Application No. 63/580,837, filed Sep. 6, 2023 and titled “Hardware Equipment Management Using Blockchain” by Pranav Tiwari.

### BACKGROUND

Industries using considerable hardware equipment have encountered significant challenges stemming from outdated data systems, fragmented data sources, duplicated information, lack of distinct identification codes, restricted interoperability with standard solutions, and complex data governance. To combat these issues, the energy sector, for example, leaned on Materials Standards and Codes (“MSC”) concepts for effective master data management. However, even with the advent of Enterprise Resource Planning (“ERP”) systems, certain aspects of these concepts eroded over time. As such, challenges persist in effectively managing industrial equipment and their metadata.

### SUMMARY

A method includes generating a data representation of a piece of hardware equipment. The method further includes generating a cryptographic hash of 1) the data representation of the piece hardware equipment combined with 2) a hash of a previous piece of hardware equipment on a blockchain data structure. The method further includes adding the data representation of the hardware equipment to the blockchain data structure, storing a copy of the blockchain data structure, and using the generated cryptographic hash similarly for a next piece of hardware equipment.

A non-transitory computer-readable medium, which when executed by a processor, causes the processor to generate a data representation of a piece of hardware equipment. The processor generates a cryptographic hash of 1) the data representation of the piece hardware equipment combined with 2) a hash of a previous piece of hardware equipment on a blockchain data structure. The processor adds the data representation of the hardware equipment to the blockchain data structure, stores a copy of the blockchain data structure into non-volatile storage, and uses the generated cryptographic hash similarly for a next piece of hardware equipment.

A system includes a first computing node, and a second computing node. The first computing node generates a data representation of a piece of hardware equipment. The first computing node generates a cryptographic hash of 1) the data representation of the piece hardware equipment combined with 2) a hash of a previous piece of hardware equipment on a blockchain data structure. The first computing node adds the data representation of the hardware equipment to the blockchain data structure, stores a copy of the blockchain data structure into non-volatile storage, and sends an update to the blockchain data structure to the second computing node. The first computing node uses the generated cryptographic hash similarly for a next piece of hardware equipment. The second computing node updates another copy of the blockchain data structure into another non-volatile storage with the sent update.

### BRIEF DESCRIPTION OF THE DRAWINGS

Accordingly, systems, methods, and non-transitory computer-readable mediums for hardware equipment management are disclosed herein. In the drawings:

FIG. 1 depicts a method for hardware equipment management in at least one illustrated embodiment;

FIG. 2 depicts a system for hardware equipment management in at least one illustrated embodiment;

FIG. 3 depicts a system for hardware equipment management in at least one illustrated embodiment; and

FIG. 4 depicts a non-transitory computer-readable medium for hardware equipment management in at least one illustrated embodiment.

### NOTATION AND NOMENCLATURE

Certain terms are used throughout the following description and claims to refer to particular system components and configurations. As one of ordinary skill will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”.

### DETAILED DESCRIPTION

The description that follows includes sample systems, methods, apparatuses, and non-transitory computer-readable mediums that embody various elements of the present disclosure. However, it should be understood that the described disclosure may be practiced in a variety of forms in addition to those described herein. For example, the examples herein use hardware equipment for the energy industry for clarity, but the present disclosure also applies to hardware equipment for other industries such as maintenance, repair, and overhaul; airlines; shipping (global logistics); third party or local logistics; defense; hotel and hospitality; aerospace; utilities (power, gas, water, electric, waste, and the like), mining (coal, iron, copper, and the like); manufacturing; engineering, procurement, and construction; railroads; and the like. Specifically, the present disclosure applies to inter-industry hardware equipment problems including one or more the following.

Interoperability Issues in Processes and Systems: One major hurdle lies in seamlessly integrating data across various processes and systems. These include elements such as ERP, digital twins for asset management, digital catalogues, bill of materials, surplus stock, warehouse management systems, logistics providers, and the like.

Challenges in Populating Metadata for Major Equipment: Several factors contribute to this challenge. First, the sheer volume of data, encompassing technical drawings, manuals, and maintenance records, can be overwhelming. Second, limited access to information scattered across different departments and systems can impede progress. Third, the potential for human error during manual data entry can lead to inaccuracies and inconsistencies. Finally, tracking maintenance requirements becomes complex due to the diverse maintenance needs of various equipment types.

Lack of Standards and Codes: The absence of UPC (Universal Product Code) or EAN (European Article Number) barcodes complicates equipment tracking and management. This can result in errors, delays, and inefficiencies in inventory management and supply chain operations.

Errors and Duplication: In the absence of a unique identifier, inventory updates may yield inaccurate counts and duplicate entries. These discrepancies can result in incorrect information about equipment maintenance schedules potentially leading to equipment failure and costly repairs. Moreover, duplicate entries for the same equipment cause confusion and hinder the ability to locate accurate information when needed.

Absence of Collective Knowledge and Insights: The lack of community feedback, collaboration, and knowledge sharing raises the likelihood of inefficiencies.

Missing Validated User Feedback and Ratings: Validated user feedback and ratings are essential for customer trust in equipment. This trust deficit can harm the reputation of both new and established manufacturers, suppliers, and vendors.

Difficulty Identifying Equipment of Interest: A deficiency in feedback data about equipment trends hampers suppliers, manufacturers, and vendors from understanding and meeting customer needs in a timely fashion.

Disclosed herein are decentralized and open master data embodiments for hardware equipment that target the fundamental sources of these challenges and facilitate the dissemination or exchange of data across various systems. Specifically, individual pieces of hardware equipment are given a data representation within a blockchain framework. Blockchain technology enhances the management of the equipment supply chain by providing an unequivocal and safeguarded record of each asset's ownership and transfer chronology. This, in turn, serves as a deterrent against fraudulent activities and guarantees the diligent maintenance and servicing of equipment throughout its lifecycle.

Next, through the utilization of smart contracts, predefined regulations and triggers may be used to generate alerts. For instance, when a specific piece of equipment crosses a designated age or usage threshold, a smart contract may promptly initiate an alert to the relevant party. Next, decentralized autonomous organizations (“DAOs”) may be used to authorize changes or updates to the blockchain within specific disciplines. The membership for a DAO may be based on tokens, and voting may be based on type of change needed. DAO members may require flat voting or weighted voting based on the tokens staked. Sub-DAOs may be used to coordinate equipment families.

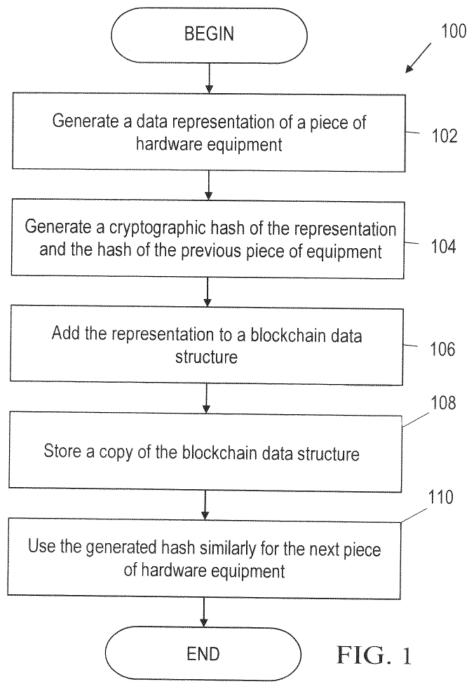

Turning to the figures, FIG. 1 illustrates a method 100 beginning at 102 and ending at 110. At 102, a data representation of a piece of hardware equipment is generated. The data representation may include attributes of the hardware equipment such as product description, unit of measure, manufacturer, manufacturer part number, weight, dimensions, dangerous goods classification, expiration lead time, operating conditions, equipment identifier, equipment images and videos, equipment features, safety attributes and certifications, equipment warranty and related services, equipment label for regulatory bodies (such as an NFPA symbol or OSHA approved confined-space warning), and the like as applicable.

Generating the data representation may include assigning a relationship between the piece of hardware equipment and another piece of hardware equipment. For example, the relationship may be a family relationship, spare relationship, service relationship, or the like described as follows.

A family relationship may include assigning the equipment to a family as in the following examples. A piping family may include a flame arrestor, funnel, ignitor, line blind, pig launcher, pig loop, pig receiver, spark arrestor, spring support, manifold, nozzle, pipe flange spade, and the like. A telecom family may include a closed-circuit television camera, microphone, modem, multiplexer, optical beacon, PABX, pager, paging system, signal splitter, video converter, termination panel, acoustic enclosure, and the like. An instrumentation family may include a flow instrument, flow conditioner, rotameter, totalizer, electronic flow controller, analyzing instrument, color analyzer, distillation analyzer, gas composition analyzer, humidity analyzer, liquid composition analyzer, level instrument, and the like. An electrical family may include a motor, transformer, generator, control module, heater plate, photoelectric device, power stabilizer, safety barrier, amplifier, circuit-breaker, control panel, power supply unit, and the like. A mechanical family may include a pump, compressor, cooler, heat exchanger, turbines, tank, vessel, louvre, damper, clamp, degasser, manual valve, and the like.

A spare relationship may include assigning the equipment as a spare or master of another piece of equipment.

A service relationship may include assigning service features and maintenance thresholds to the equipment.

Generating the data representation may also include automatically populating empty fields regarding the attributes of the piece of hardware equipment via vendor databases, catalogues, or websites. For example, using an artificial intelligence, machine learning, or natural language processing interface to a blockchain data structure may enable feeding of equipment attributes scraped from the World Wide Web, datasheets, or online databases. Web scraping tools and techniques may be employed to extract relevant information from these sources. Specifically, these tools may navigate websites, retrieve structured or unstructured data, and convert it into a usable format according to the fields needed. Natural language processing models may be used to extract structured information from unstructured text data, while machine learning models can process numeric data.

At 104, a cryptographic hash is generated including 1) the data representation of the piece hardware equipment combined with 2) a hash of a previous piece of hardware equipment on a blockchain data structure. Specifically, both items may be used as input to a cryptographic hash function. The hash function may output a fixed-size hash value unique to the specific data input. Even a slight change in the input data would result in a completely different hash. In this way, a new block is generated using the data representation of the hardware equipment that is linked to the previous block.

At 106, the data representation of the hardware equipment is added to the blockchain data structure. For example, the newly created block is stored and broadcast as an update to any connected nodes also storing a copy of the blockchain data structure. As more hardware equipment is added to the blockchain, each new block contains the hash of the current equipment's data and the hash of the previous block. This creates a chronological chain of linked blocks, where each block's data is secured by the hash of the previous block. Any attempt to modify the data in a previous block would require recalculating the hash of that block and all subsequent blocks, making tampering extremely difficult and detectable. The method 100 may include broadcasting the addition to the blockchain data structure to nodes storing a copy of the blockchain data structure.

Blockchains often employ consensus mechanisms (e.g., proof of work, proof of stake) to ensure that multiple participants in the network agree on the validity of the data being added to the blockchain. Adding the data representation of the hardware equipment to the blockchain data structure may require proof of a threshold number of tokens, the tokens allowing transactions on the blockchain data structure. Within the ecosystem, tokenomics serves as a mechanism to encourage precise data input, expedite data sharing, and establish decentralized ownership of equipment data.

At 108, a copy of the blockchain data structure is stored. For example, all the blocks, their data, and the links between them are stored or kept in non-volatile memory by updating the blockchain with the latest block. At 110, the generated cryptographic hash is used similarly for a next piece of hardware equipment. For example, the next newly-created block uses the hash of the hardware equipment as an input to the hash function.

The method 100 may include generating a smart contract for the piece of hardware equipment and adding the smart contract to the blockchain data structure. A smart contract is a self-executing computer program that runs on a blockchain. It automatically executes predefined actions or agreements when specific conditions are met. Relevant data from the piece of hardware equipment may be integrated into the smart contract. For example, the features of a smart contract regarding hardware equipment may include unique identifier, attributes, performance metrics, warranty details, maintenance schedules, usage restrictions, ownership transfers, and the like. The smart contract's logic may contain if-then-else statements that specify the triggers (events) and associated actions. For example, if the equipment reaches a certain usage threshold, the contract may trigger a maintenance request or a warranty claim. Also, smart contracts enable creation of different sets of conditions for different equipment types. For example, an initial validation of equipment data may include a different threshold number of attributes for each equipment type to be valid. A motor or pump may require 28 attributes to receive a unique ID, while a tank may require 12 for the same. Adding the smart contract to the blockchain may include broadcasting the code in a block to nodes that execute and validate the contract through consensus mechanisms ensuring that the contract adheres to the rules of the blockchain. Users, participants, or other smart contracts may interact with the deployed smart contract by sending transactions or invoking its functions. If updates or modifications are needed, new versions of the smart contract can be created, and the blockchain's consensus mechanisms may ensure that all participants agree on the changes.

The method 100 may include generating a unique number for the piece of hardware equipment, the unique number used to share the data representation via uniform resource locater (“URL”), barcode, or quick response (“QR”) code. A unique number is a distinct identifier assigned to each individual piece of hardware equipment. This number ensures that each piece of equipment can be easily identified and distinguished from others. The unique number may be embedded in a URL, allowing users to access detailed information about the equipment by simply entering the URL into a web browser. The unique number may be encoded into a barcode or QR code format, which may be printed on a label attached to the equipment. Scanning the barcode with a barcode reader or a smartphone app may instantly retrieve the associated data representation. Organizations may develop mobile apps or online platforms that allow users to enter or scan the unique number to access comprehensive information about the equipment via the blockchain. Accordingly unique number enhances traceability and provides a user-friendly way for stakeholders to access details about the equipment's specifications, history, maintenance records, and the like.

Users may do more than add the data representation of hardware equipment to the blockchain. For example, the method 100 may include exporting blockchain data to an electronic document management system, a digital twin virtual model, or an ERP system.

An electronic document management system (“EDMS”) is a software solution designed to manage, store, organize, and track digital documents and files. Exporting blockchain data to an EDMS may include integrating blockchain data with the features and capabilities of such a system:
Data Mapping: Relevant blockchain data, such as equipment specifications, maintenance records, ownership history, and smart contract details, is mapped to corresponding fields within the EDMS.
Metadata Integration: Metadata associated with blockchain transactions or data entries can be used to enhance document metadata in the EDMS. This helps in better categorization, searching, and retrieval of documents.
Document Linking: Documents within the EDMS can be linked to specific blockchain transactions or data points, creating a seamless connection between the data recorded on the blockchain and the associated documents.
Document Versioning: EDMS often provides version control for documents. The integration with blockchain data ensures that changes made to documents are tracked and authenticated.
Auditing and Compliance: Combining blockchain's immutability with the features of an EDMS enhances auditing and compliance efforts by providing a secure and tamper-proof record of document changes and approvals.

A digital twin is a virtual representation of a physical object, process, or system. Exporting blockchain data to a digital twin model may allow for real-time synchronization and enhanced insights:
Data Synchronization: The digital twin model may be updated with the latest blockchain data, ensuring that the virtual representation remains accurate and reflective of the physical equipment's current state.
Real-time Monitoring: By integrating blockchain data, the digital twin may provide real-time insights into equipment performance, maintenance needs, and other relevant metrics.
Predictive Analysis: Utilizing both blockchain and digital twin technologies may enable predictive analysis and simulation, helping to identify potential issues and optimize performance.
Remote Diagnostics: Maintenance and operational teams may remotely access the digital twin to diagnose equipment status and make informed decisions based on the latest blockchain data.

An ERP system integrates and manages various business processes and data within an organization. Exporting blockchain data to an ERP system may enhance data-driven decision-making and streamline operations:
Unified Data: The ERP system may incorporate blockchain data to provide a comprehensive view of equipment-related information, financial transactions, supply chain data, and the like.
Supply Chain Transparency: For equipment involving supply chains, integrating blockchain data into the ERP system may enhance transparency and traceability of components, materials, and vendors.
Streamlined Processes: Automating processes using blockchain data within the ERP system may lead to increased efficiency, reduced manual intervention, and minimized errors.
Decision Support: Decision-makers can access real-time blockchain data through the ERP system to make informed choices about inventory, maintenance, procurement, and resource allocation due to the uniformity of equipment data required for acceptance on the blockchain.

As another example, the method 100 may include exporting the data representation of the hardware equipment from the blockchain data structure for display on a website enabling users to comment on the hardware equipment with text, pictures, or videos. For example, an application programming interface may connect the website with the blockchain data. Exporting blockchain data for display and user interaction on a website offers several benefits:
Transparency and Trust: Users can access verified and tamper-proof information about the hardware equipment, promoting transparency and trust.
User Engagement: Allowing users to comment, share insights, and discuss the equipment encourages engagement and community interaction.
Collaboration: Different stakeholders, such as manufacturers, users, and maintenance personnel, can collaborate by sharing their perspectives, experiences, and suggestions.
Feedback and Improvement: Comments can provide valuable feedback, helping manufacturers enhance product quality, address issues, and make improvements based on user insights.
Education and Information: The website becomes a platform for educating users about the equipment's features, benefits, and proper usage.
Marketing and Promotion: Manufacturers can use the website to showcase their products and engage with potential customers.

Similarly, the method 100 may include one or more of the following user actions.
Access and View Equipment Data: Users may access and view data associated with equipment such as equipment attributes.
Users may ask questions and consult a list of frequently asked questions (“FAQs”) enabling collaboration between manufacturers and users.
Users may tag other equipment, assets, organizations, and the like.
Add and Edit Equipment Information: Users may introduce new equipment data or revise existing entries, ensuring the accuracy and currency of information. This includes updating recommended spare parts, affiliated components, adding fresh equipment entries, amending equipment attributes, and the like with the results being reflected in the blockchain.
Search and Filter Equipment Data: Users may conduct targeted searches for specific equipment or employ filters based on a range of criteria including equipment type, feedback, country of origin, and the like.
Analyze Equipment Insights: Users may view or analyze equipment reliability, usage patterns, and performance data to discern trends and patterns.
Enhance Feedback with Visuals: Users may provide visual feedback through image and video uploads, supplementing their written reviews.
Rate Equipment: By sharing their firsthand experiences, users may rate equipment, contributing to an overall rating that assists other users in making well-informed equipment choices.
Download Metadata: Users may download metadata for individual or multiple pieces of equipment, selecting their preferred format such as CSV, XML, or JSON.
Request New Equipment Types: Users may propose the creation of novel equipment types, especially when existing categories do not accommodate specific equipment. Stakeholders, including suppliers and peers, may evaluate and classify the new type within the hierarchy.
Share Equipment via Social Channels: Users may disseminate equipment information on social media platforms, fostering awareness and offering insights into their personal experiences.
Earn Rewards for Metadata Validation: Users may receive rewards, such as points, tokens, or digital assets, for validating equipment metadata, redeemable for incentives, premium features, or blockchain transaction rights.
Verified Registration: Users may register on the platform by verifying their identity, ensuring authenticity and credibility.
Seamless Integration: Users may integrate equipment data with diverse systems, encompassing ERP, digital twins, digital catalogues, warehouse management, and logistics providers.
Equipment Voting: Users may partake in equipment voting, influencing popularity and relevance determinations.

The user actions may require payment of tokens. For example, Ethereum uses a gas fee concept to drive transactions. As such, examples of gas fees include the following.
Adding New Equipment(s): Requires payment of a gas fee of 0.02 tokens per equipment.
Updating Equipment: Requires a Gas fee of 0.008 tokens per equipment.
Reviewing Equipment and Assigning Ratings: requires a gas fee of 0.002 tokens per review. The first review on a piece of equipment earns a reward of 0.01 token.
Adding Image/Video with Review Description: Requires a gas fee of 0.002 tokens per image/video review. The first image/video review on a piece of equipment receives a reward of 0.02 token.
Downloading Metadata of Equipment(s): No gas fees.
Searching Equipment(s): No gas fees.
Requesting Creation of New Equipment Type: No gas fees. Request approval by the sub-DAO moderator.
Sharing Equipment via Social Platforms: No gas fees.
Earning Reward for Validating Metadata: Users earn 0.005 tokens for each validation.
Registering as a New User/Manufacturer/Supplier without KYC/Proof of Personhood:
Users earn 1 token.
Registering as an Authentic User/Manufacturer/Supplier with Proof of Personhood: Users earn 5 tokens.
Referring a Friend: Users earn 2 tokens.
Validating Equipment Metadata: Staking 0.002 tokens.
Finding Suppliers for Equipment Type: No gas fees.
Downloading a List of Suppliers for Equipment: No gas fees.
Registering as a Manufacturer/Supplier/Enterprise/Operator: No gas fees.
Initiating a New Proposal: No gas fees.

### Vetting Proposals by Other Users: No Gas Fees.

A decentralized autonomous organization (“DAO”) may restrict access to transactions on the blockchain data structure via proof-of-stake and smart contracts. A DAO refers to an organization that operates based on a set of smart contracts and protocols, without the need for centralized control or intermediaries. In a DAO, decision-making processes, governance, and actions are automated and executed through code on a blockchain. The objective of DAO governance is to establish a system characterized by democracy, transparency, and efficiency, granting each stakeholder a participatory role in decision-making. The influence in decision-making is based on the quantity of tokens held by each participant, resulting in proportional representation during the voting phase. Community members propose concepts, subsequently subject to democratic voting by token holders. This procedure is facilitated by the deployment of smart contracts, ensuring seamless execution. Upon the approval of a proposal, the smart contract autonomously enacts the requisite modifications or actions, obviating the necessity for human intervention.

The DAO may serve as a coordinating force for sub-DAOs, assuming a role in communication and coordination among them. This involves formulating guidelines and mandates for the sub-DAOs as well as intervening to address any conflicts or challenges that may emerge between these entities. The sub-DAOs may restrict access to transactions on the blockchain data structure via proof-of-stake and smart contracts for separate families of hardware equipment.

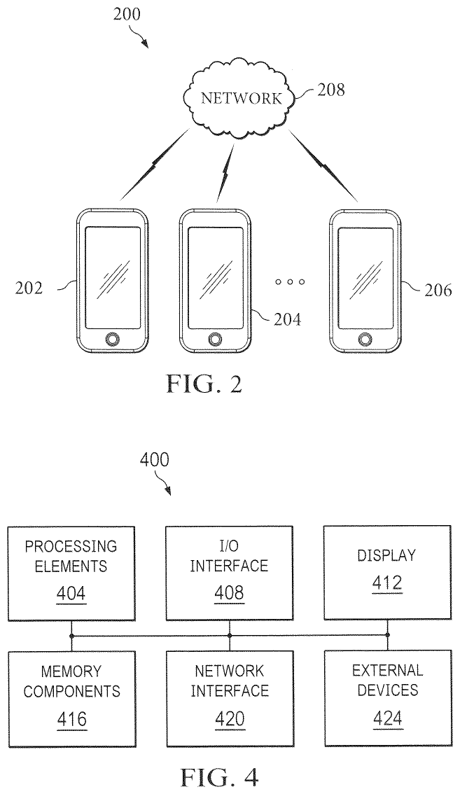

Turning to FIG. 2, a system 200 includes a first computing node 202, and a second computing node 204. More computing nodes 206 may be included as well, each node connected via a network 208 in at least one embodiment. Nodes 202, 204 actively participate in the consensus process of validating all transactions and data updates. Each node 202, 204 stores a complete and current copy of the entire blockchain, housing records of all past transactions and smart contracts locally. As such, they include storage capacity, processing capabilities, and networking hardware. In at least one embodiment, the first computing node 202 generates a data representation of a piece of hardware equipment as described above. Specifically, the first computing 202 node may generate a cryptographic hash of 1) the data representation of the piece hardware equipment combined with 2) a hash of a previous piece of hardware equipment on a blockchain data structure. The first computing node 202 may add the data representation of the hardware equipment to the blockchain data structure, store a copy of the blockchain data structure into non-volatile storage, and send an update to the blockchain data structure to the second computing node 204. The first computing node 202 uses the generated cryptographic hash similarly for a next piece of hardware equipment. The second computing node 204 updates another copy of the blockchain data structure into another non-volatile storage with the sent update.

The embodiments described herein may be implemented as logical operations and/or modules in one or more systems. The logical operations may be implemented as a sequence of processor-implemented steps directed by software programs executing in one or more computer systems and as interconnected machine or circuit modules within one or more computer systems, or as a combination of both. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language. Modules may include the following.

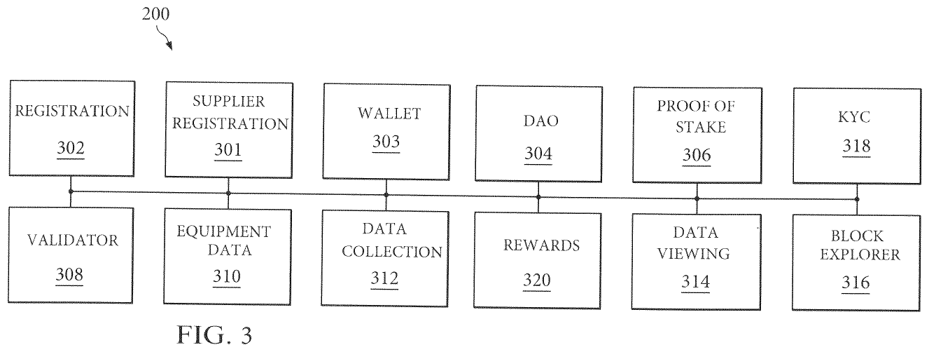

Turning to FIG. 3, the system 200 may be implemented as multiple modules. Registration Module 302: The system 300 may be accessible to all stakeholders who create an account. To create an account, users may provide a Username, Password, Profile Image, and email address.

Supplier Registration Module 301: To register as a supplier, users may additionally provide a Supplier Name, Address, and Biography. Upon successful registration, suppliers may gain access to a supplier dashboard.

Wallet Module 303: Upon successful completion of the registration process whether supplier or otherwise, a custodial wallet is generated on the blockchain for each user, utilizing their email address. This custodial wallet may generate the user's private key and public key. The wallet provides a safe and reliable repository for the user's data, ensuring that their information is protected from unauthorized access and tampering. To further safeguard the private keys associated the custodial wallets, a Key Management Service may be used to encrypt the private keys, adding an additional layer of protection.

DAO Module 304: As described above, the DAO operates autonomously, governed by smart contracts on the blockchain, allowing stakeholders to actively participate in decision-making and collectively manage the system 200. This implementation promotes transparency, decentralization, and stakeholder engagement, enhancing the overall effectiveness and integrity of our system. For instance, stakeholders such as peers and suppliers may participate in voting on system updates, proposals for changes to the master data, and the like. The DAO may also establish rules and regulations for data access, usage, and validation, ensuring that the system 200 operates in a transparent and democratic manner. Additionally, the DAO may enable stakeholders to contribute to the development and maintenance of the system 200 through incentivized mechanisms, such as token rewards. This can foster collaboration, engagement, and ownership among stakeholders, leading to a more robust and community-driven system.

Proof of Stake (PoS) Module 306: Because the blockchain operates sans centralized governing authorities, PoS guarantees the validity of stored data on the network.

Validator Module 308: In the system 200, validators are nodes 202, 204 engaged in the process of transaction validation and subsequent blockchain inclusion. Validators may preserve the integrity, security, and decentralization of the blockchain by following the protocol for confirming transactions and appending them to the blockchain. Accordingly, validators may lock a predetermined quantity of tokens, termed their “stake,” within a smart contract on the blockchain. This participation earns validators the privilege of validating new transactions and securing rewards for their active engagement.

Equipment Data Model & Structure Module 310: This module may delineate the format and structure of data for the data representation of equipment. As such, it ensures uniformity and standardization across diverse data sources.

Data Collection/Staging Module 312: This module may be responsible for extracting, transforming, and loading data from various sources into the system 200. As such, this module guarantees data cleanliness, precision, and readiness.

Data Viewing and Validation Module 314: This module may offer a user-friendly interface for viewing and validating data. As such, it allows users to swiftly access information amassed from multiple points, fortified by validation checks ensuring data integrity.

Blockchain/Blockchain Explorer Module 316: This module may be allow users to monitor blockchain transactions and activities.

Know Your Customer Verification Module 318: User access may be verified through a KYC process, curbing fraudulent or unauthorized entry.

Rewards System Module 320: A token-based rewards module may encourage user engagement, incentivizing contributions and fostering a collaborative community.

FIG. 4 illustrates a non-transitory computer-readable medium, which when executed by a processor, causes the processor to perform any appropriate action described herein. For example, the processor may perform any applicable action described in the method 100 or system 200 above. A computer system 400 may be used to implement the platform generally. The computer system 400 is used to implement or execute one or more of the components or operations disclosed herein, and the computer system 400 may include one or more processing elements 404, an input/output interface 408, a display 412, one or more memory components 416, a network interface 420, and one or more external devices 424. Each of the various components may be in communication with one another through one or more buses, communication networks, such as wired or wireless networks.

The processing element 404 may be any type of electronic device capable of processing, receiving, and/or transmitting instructions. For example, the processing element 404 may be a central processing unit, graphics processing unit, microprocessor, processor, or microcontroller. Additionally, it should be noted that some components of the computer 400 may be controlled by a first processor and other components may be controlled by a second processor, where the first and second processors may or may not be in communication with each other.

The memory components 416 are used by the computer 400 to store instructions for the processing element 404, as well as store data. The memory components 416 may be, for example, magneto-optical storage, read-only memory, random access memory, erasable programmable memory, flash memory, or a combination of one or more types of memory components. Secondary storage may be comprised of one or more disk drives or tape drives and is used for non-volatile storage of data and as an over-flow data storage device if RAM is not large enough to hold all working data. Secondary storage may be used to store programs which are loaded into RAM when such programs are selected for execution. The ROM is used to store instructions and perhaps data which are read during program execution. ROM is a non-volatile memory device which typically has a small memory capacity relative to the larger memory capacity of secondary storage. The RAM is used to store volatile data and perhaps to store instructions. Access to both ROM and RAM is typically faster than to secondary storage. The secondary storage, the RAM, and/or the ROM may be referred to in some contexts as computer readable storage media and/or non-transitory computer readable media.

The display 412 provides visual feedback to a user. The display 412 may be a liquid crystal display, plasma display, organic light-emitting diode display, and/or other suitable display. In embodiments where the display 412 is used as an input, the display may include one or more touch or input sensors, such as capacitive touch sensors, a resistive grid, or the like.

The I/O interface 408 allows a user to enter data into the computer 400, as well as provides an input/output for the computer 400 to communicate with other devices or services. The I/O interface 408 can include one or more input buttons, touch pads, and so on. I/O devices may include printers, video monitors, liquid crystal displays (LCDs), touch screen displays, keyboards, keypads, switches, dials, mice, track balls, voice recognizers, card readers, paper tape readers, or other well-known input devices.

The network connectivity devices may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. These network connectivity devices may enable the processor to communicate with the Internet or one or more intranets. With such a network connection, it is contemplated that the processor might receive information from the network, or might output information to the network in the course of performing the above-described method steps. Such information, which is often represented as a sequence of instructions to be executed using processor, may be received from and outputted to the network, for example, in the form of a computer data signal embodied in a carrier wave.

Such information, which may include data or instructions to be executed using processor for example, may be received from and output to the network, for example, in the form of a computer data baseband signal or signal embodied in a carrier wave. The baseband signal or signal embedded in the carrier wave, or other types of signals currently used or hereafter developed, may be generated according to several methods known to one skilled in the art.

In some cases, the computing system 400 may be server implemented over a distributed network. The distributed network may include or otherwise facilitate communication with a plurality of user devices in communication with one another via a network. The network may include the server of system 400 to the communication and to perform one or more of the operations described herein. The server, or other network enabled device, may include substantially any type of computing device but typically may be one or more computing devices in communication with one another that perform one or more tasks for the user devices. In some embodiments, the server may be a computing device that hosts a web server application or other software application that transmits and receives data to and from the user devices. For example, such server may typically include one or more processing elements, memory components, and networking/communication interfaces, but may generally have a larger processing power and memory storage as compared to the client or user devices.

The user devices may also be substantially any type of computing device. In many embodiments the user devices are portable computing devices with an integrated display, such as a smart phone. It should be noted that in many embodiments, the distributed network may include a querying user device and responsive or member user devices. The user devices may be configured to display the dashboard and/or any of the user interfaces described herein.

It is understood that by programming and/or loading executable instructions onto the computer system, at least one of the CPU, the RAM, and the ROM are changed, transforming the computer system in part into a particular machine or apparatus having the novel functionality taught by the present disclosure.

In some aspects, methods, systems, and non-transitory computer readable mediums are provided according to one or more of the following examples:

### Example 1

A method includes generating a data representation of a piece of hardware equipment. The method further includes generating a cryptographic hash of 1) the data representation of the piece hardware equipment combined with 2) a hash of a previous piece of hardware equipment on a blockchain data structure. The method further includes adding the data representation of the hardware equipment to the blockchain data structure, storing a copy of the blockchain data structure, and using the generated cryptographic hash similarly for a next piece of hardware equipment.

### Example 2

A non-transitory computer-readable medium, which when executed by a processor, causes the processor to generate a data representation of a piece of hardware equipment. The processor generates a cryptographic hash of 1) the data representation of the piece hardware equipment combined with 2) a hash of a previous piece of hardware equipment on a blockchain data structure. The processor adds the data representation of the hardware equipment to the blockchain data structure, stores a copy of the blockchain data structure into non-volatile storage, and uses the generated cryptographic hash similarly for a next piece of hardware equipment.

### Example 3

A system includes a first computing node, and a second computing node. The first computing node generates a data representation of a piece of hardware equipment. The first computing node generates a cryptographic hash of 1) the data representation of the piece hardware equipment combined with 2) a hash of a previous piece of hardware equipment on a blockchain data structure. The first computing node adds the data representation of the hardware equipment to the blockchain data structure, stores a copy of the blockchain data structure into non-volatile storage, and sends an update to the blockchain data structure to the second computing node. The first computing node uses the generated cryptographic hash similarly for a next piece of hardware equipment. The second computing node updates another copy of the blockchain data structure into another non-volatile storage with the sent update.

The following features may be incorporated into the various embodiments described above, such features incorporated either individually in or conjunction with one or more of the other features: The method may include generating a smart contract for the piece of hardware equipment and adding the smart contract to the blockchain data structure. The method may include generating a unique number for the piece of hardware equipment, the unique number used to share the data representation via uniform resource locater (“URL”), barcode, or quick response (“QR”) code. Adding the data representation of the hardware equipment to the blockchain data structure may require proof of a threshold amount of tokens, the tokens allowing transactions on the blockchain data structure. A decentralized autonomous organization (“DAO”) may restrict access to transactions on the blockchain data structure via proof-of-stake and smart contracts. Separate sub-DAOs may restrict access to transactions on the blockchain data structure via proof-of-stake and smart contracts for separate families of hardware equipment. Generating the data representation may include assigning a relationship between the piece of hardware equipment and another piece of hardware equipment, the relationship selected from the group consisting of family relationship, spare relationship, and service relationship. Generating the data representation may include automatically populating empty fields regarding the attributes of the piece of hardware equipment via vendor databases, catalogues, or websites. Automatically populating empty fields may include using an artificial intelligence, machine learning, or natural language processing interface to the blockchain data structure to feed the attributes scraped from the World Wide Web, datasheets, or online databases. The method may include exporting blockchain data to an electronic document management system, a digital twin virtual model, or an enterprise resource planning (“ERP”) system. The method may include exporting the data representation of the hardware equipment from the blockchain data structure for display on a website enabling users to comment on the hardware equipment with text, pictures, or videos. The method may include broadcasting the addition to the blockchain data structure to nodes storing a copy of the blockchain data structure. The processor may generate a smart contract for the piece of hardware equipment and adding the smart contract to the blockchain data structure. Adding the data representation of the hardware equipment to the blockchain data structure may require proof of a threshold amount of tokens, the tokens allowing transactions on the blockchain data structure. A decentralized autonomous organization (“DAO”) may restrict access to transactions on the blockchain data structure via proof-of-stake and smart contracts. Separate sub-DAOs may restrict access to transactions on the blockchain data structure via proof-of-stake and smart contracts for separate families of hardware equipment. Generating the data representation may cause the processor to automatically populate empty fields regarding the attributes of the piece of hardware equipment via vendor databases, catalogues, or websites. The processor may be further caused to edit an automatically-populated field via user access to the blockchain data structure.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments in this disclosure have been described in terms of preferred embodiments, those skilled in the art will recognize that the embodiments herein can be practiced with modification within the spirit and scope of the embodiments as described herein. Numerous other modifications, equivalents, and alternatives, will become apparent once the above disclosure is fully appreciated. It is intended that the following claims be interpreted to embrace all such modifications, equivalents, and alternatives where applicable.

What is claimed is:

1. A method, comprising:
generating a data representation of a piece of hardware equipment;
generating a cryptographic hash of 1) the data representation of the piece hardware equipment combined with 2) a hash of a previous piece of hardware equipment on a blockchain data structure;
adding the data representation of the hardware equipment to the blockchain data structure;
storing a copy of the blockchain data structure; and
using the generated cryptographic hash similarly for a next piece of hardware equipment.

2. The method of claim 1, further comprising generating a smart contract for the piece of hardware equipment and adding the smart contract to the blockchain data structure.

3. The method of claim 1, further comprising generating a unique number for the piece of hardware equipment, the unique number used to share the data representation via uniform resource locater (“URL”), barcode, or quick response (“QR”) code.

4. The method of claim 1, wherein adding the data representation of the hardware equipment to the blockchain data structure requires proof of a threshold amount of tokens, the tokens allowing transactions on the blockchain data structure.

5. The method of claim 1, wherein a decentralized autonomous organization (“DAO”) restricts access to transactions on the blockchain data structure via proof-of-stake and smart contracts.

6. The method of claim 5, wherein separate sub-DAOs restrict access to transactions on the blockchain data structure via proof-of-stake and smart contracts for separate families of hardware equipment.

7. The method of claim 1, wherein generating the data representation comprises assigning a relationship between the piece of hardware equipment and another piece of hardware equipment, the relationship selected from the group consisting of family relationship, spare relationship, and service relationship.

8. The method of claim 1, wherein generating the data representation comprises automatically populating empty fields regarding the attributes of the piece of hardware equipment via vendor databases, catalogues, or websites.

9. The method of claim 8, wherein automatically populating empty fields comprises using an artificial intelligence, machine learning, or natural language processing interface to the blockchain data structure to feed the attributes scraped from the World Wide Web, datasheets, or online databases.

10. The method of claim 1, further comprising exporting blockchain data to an electronic document management system, a digital twin virtual model, or an enterprise resource planning (“ERP”) system.

11. The method of claim 1, further comprising exporting the data representation of the hardware equipment from the blockchain data structure for display on a website enabling users to comment on the hardware equipment with text, pictures, or videos.

12. The method of claim 1, further comprising broadcasting the addition to the blockchain data structure to nodes storing a copy of the blockchain data structure.

13. A non-transitory computer-readable medium, which when executed by a processor, causes the processor to:
generate a data representation of a piece of hardware equipment;
generate a cryptographic hash of 1) the data representation of the piece hardware equipment combined with 2) a hash of a previous piece of hardware equipment on a blockchain data structure;
add the data representation of the hardware equipment to the blockchain data structure;
store a copy of the blockchain data structure into non-volatile storage; and
use the generated cryptographic hash similarly for a next piece of hardware equipment.

14. The computer-readable medium of claim 13, further causing the processor to generate a smart contract for the piece of hardware equipment and adding the smart contract to the blockchain data structure.

15. The computer-readable medium of claim 13, wherein adding the data representation of the hardware equipment to the blockchain data structure requires proof of a threshold amount of tokens, the tokens allowing transactions on the blockchain data structure.

16. The computer-readable medium of claim 13, wherein a decentralized autonomous organization (“DAO”) restricts access to transactions on the blockchain data structure via proof-of-stake and smart contracts.

17. The computer-readable medium of claim 16, wherein separate sub-DAOs restrict access to transactions on the blockchain data structure via proof-of-stake and smart contracts for separate families of hardware equipment.

18. The computer-readable medium of claim 13, wherein generating the data representation causes the processor to automatically populate empty fields regarding the attributes of the piece of hardware equipment via vendor databases, catalogues, or websites.

19. The computer-readable medium of claim 18, wherein the processor is further caused to edit an automatically-populated field via user access to the blockchain data structure.

20. A system, comprising:
a first computing node; and
a second computing node;
wherein the first computing node:
generates a data representation of a piece of hardware equipment;
generates a cryptographic hash of 1) the data representation of the piece hardware equipment combined with 2) a hash of a previous piece of hardware equipment on a blockchain data structure;
adds the data representation of the hardware equipment to the blockchain data structure;
stores a copy of the blockchain data structure into non-volatile storage;
sends an update to the blockchain data structure to the second computing node; and
uses the generated cryptographic hash similarly for a next piece of hardware equipment; and
wherein the second computing node updates another copy of the blockchain data structure into another non-volatile storage with the sent update.
